(19) United States
(12) Patent Application Publication
(10) Pub. No.: US 2019/0345031 A1
(43) Pub. Date: Nov. 14, 2019

(54) METHOD FOR THE PRODUCTION OF A SYNGAS FROM A STREAM OF LIGHT HYDROCARBONS AND FROM COMBUSTION FUMES FROM A CEMENT CLINKER PRODUCTION UNIT

(71) Applicants: IFP Energies nouvelles, Rueil-Malmaison (FR); HOLCIM TECHNOLOGY LTD, Jona (CH)

(72) Inventors: Antoine FECANT, Brignais (FR); Alain FAVRE, Ternay (FR); Michel GIMENEZ, Diemoz (FR); Carlos SANTOS RAMOS, Lyon (FR)

(73) Assignees: IFP Energies nouvelles, Rueil-Malmaison (FR); HOLCIM TECHNOLOGY LTD, Jona (CH)

(21) Appl. No.: 16/464,801

(22) PCT Filed: Nov. 6, 2017
(86) PCT No.: PCT/EP2017/078302

§ 371 Date: May 29, 2019

(30) Foreign Application Priority Data
Nov. 29, 2016 (FR) 1661618

(51) Int. Cl. C01B 3/38; C04B 7/36

(52) U.S. Cl. CPC C01B 3/382; C04B 7/367; C01B 2203/0244; C04B 2290/20; C01B 2203/0811; C01B 2203/143; C01B 2203/1047; C01B 2203/062

(57) ABSTRACT

A process for producing a syngas containing CO and H₂ from a stream of light hydrocarbons and from combustion flue gases from a cement clinker production unit comprising at least one calcining kiln (300), and a means for discharging the combustion flue gases (500) from the calcining kiln to the outside of said unit, said process comprising the following steps:
at least some of the combustion flue gases (70) obtained in said clinker production unit are collected upstream of said means for discharging the combustion flue gases (500);
a reaction stream (113) comprising a stream of light hydrocarbons (110) containing methane and the combustion flue gases (70) is prepared;
said reaction stream (113) is sent to a tri-reforming reactor (1009) to obtain a syngas (114).

### TECHNICAL FIELD

The invention relates to the field of the production of syngas using a tri-reforming reaction by means of combustion flue gases from a cement clinker production unit. The syngas obtained makes it possible to produce paraffinic or olefinic hydrocarbons, which are high-quality liquid fuel bases (diesel fraction with a high cetane index, kerosene, etc.) or petrochemical bases, that can be obtained more particularly by means of a Fischer-Tropsch synthesis step.

### PRIOR ART

Several processes for producing syngas from carbon-based materials, in particular the partial oxidation reaction and methane reforming, are known.

Partial oxidation, or gasification by partial oxidation (known by the initials PDX), consists in forming, by combustion under sub-stoichiometric conditions, a mixture at high temperature, generally between 1000° C. and 1600° C., of, on the one hand, carbon-based material and, on the other hand, of air or oxygen, in order to oxidize the carbon-based material and to obtain a syngas. Partial oxidation is compatible with any forms of carbon-based feedstocks, including heavy feedstocks. The partial oxidation reaction corresponds to the balanced equation (1) below:

½ O₂+CH₄<=>CO+2H₂ (1)

Methane reforming is a chemical reaction which consists in producing hydrogen from methane. Two types of methane reforming process are distinguished. Steam methane reforming, known by the initials SMR, consists in reacting the feedstock, typically a natural gas or light hydrocarbons, on a catalyst in the presence of steam in order to obtain a syngas which contains mainly, other than steam, a mixture of carbon monoxide and hydrogen. Steam methane reforming is an endothermic reaction, the H₂/CO molar ratio of which is close to 3. Steam methane reforming corresponds to the following balanced equation (2):

CO₂+CH₄<=>2CO+2H₂ (2)

Moreover, dry reforming is a strongly endothermic reaction, the H₂/CO molar ratio of which is close to 1. Dry reforming corresponds to the following balanced equation (3):

CH₄+H₂O<==>CO+3H₂ (3)

However, the H₂/CO ratios of the syngas produced during dry reforming or steam methane reforming are not satisfactory for the production of fuels which require an H₂/CO molar ratio of about 2. The combination of these two processes makes it possible to obtain ratios closer to those desired, but the resulting production of carbon (“coke”) on the catalyst is a major drawback.

A solution proposed in the prior art consists in combining three catalytic reactions: dry reforming, steam methane reforming and the partial oxidation reaction, these three reactions all being carried out in one and the same reactor. This reaction combination is known as catalytic tri-reforming. Catalytic tri-reforming is advantageous for the formation of syngas. Indeed, Song et al. (Chemical innovation, 31 (2001) 21-26) describe a process for reacting, at high temperature, a gas comprising CH₄, CO₂, O₂ and H₂O in the presence of a catalyst so as to produce CO and H₂ in controlled ratios.

Document US2008/0260628 discloses a process for producing syngas, comprising a methane reforming reaction step by supplying a mixture of carbon dioxide, steam and oxygen and using a nickel-based catalyst.

Document US2015/0031922 describes a process for producing syngas by catalytic tri-reforming using a mixture of hydrocarbons, of CO₂, of H₂O and of O₂. The CO₂ comes from combustion gases from various industrial processes, obtained after a separation step, in particular by separation with amine washing.

The catalytic tri-reforming makes it possible in particular to exploit the CO₂ from the combustion flue gases (also referred to herein as combustion gases) of power plants (Song et al., Prepr. Pap.-Am. Chem. Soc., Div. Fuel Chem., 2004, 49(1), 128). The syngas thus obtained can then be exploited by Fischer-Tropsch reaction, in particular for the production of synthesis fuels.

Thus, it is known from the prior art to use a combustion gas from an industrial unit in tri-reforming reactions. However, the combustion gases are taken at the outlet of kiln chimneys, and therefore have a temperature that is not very high, i.e. Approximately 150° C. [cf. Song et al., Prepr. Pap.-Am. Chem. Soc., Div. Fuel Chem., 2004, 49(1), 128]. Consequently, it is necessary to reheat the combustion gases to the tri-reforming reaction temperature, i.e. a temperature typically of between 650 and 900° C. Moreover, the relatively low temperature of the combustion gases at the chimney outlet can lead to the condensation of steam contained in the combustion gases and therefore can substantially modify the H₂O/Hydrocarbon (HC) ratio, which would no longer be optimal for the catalytic tri-reforming reaction.

The applicant has developed a novel process for producing a syngas obtained from a catalytic tri-reforming reaction using directly, preferably without steps of intermediate separation of the CO₂, combustion flue gases from the cement clinker production unit kiln, upstream of the chimneys for discharging the combustion flue gases to the outside of the cement clinker production unit. Indeed, the combustion flue gases from the cement clinker production unit have the advantage of containing a high CO₂ concentration because of the decarbonation of the raw material during the clinkering step. This allows a production of syngas with a better energy yield, a lower discharge of greenhouse gases, and a high carbon yield.

### SUBJECTS OF THE INVENTION

A subject of the present invention is a process for producing a syngas containing CO and H₂ from a stream of light hydrocarbons and from combustion flue gases from a cement clinker production unit comprising at least one calcining kiln, and a means for discharging the combustion flue gases from the calcining kiln to the outside of said unit, said process comprising the following steps:
a) at least some of the combustion flue gases obtained in said clinker production unit are collected upstream of said means for discharging the combustion flue gases, preferably without carrying out an intermediate separation step;
b) optionally, said combustion flue gases collected in step a) are treated to obtain treated combustion flue gases;
c) a reaction stream comprising a stream of light hydrocarbons containing methane and the combustion flue gases obtained in step a) or the treated combustion flue gases obtained in step b) is prepared; and
d) said reaction stream is sent to a tri-reforming reactor to obtain a syngas, said tri-reforming reactor operating at a temperature of between 650 and 900° C., a pressure of between 0.1 and 5 MPa, and an HSV of between 0.1 and 200 Nm³/h.kg catalyst.

Advantageously, when the cement clinker production unit comprises a preheater using the combustion flue gases as heat source, placed upstream of the calcining kiln, the combustion flue gases are collected at the level of the preheater of said cement clinker production unit.

Preferably, when the preheater is a multi-cyclone preheater, said combustion flue gases are collected at the level of the penultimate or final cyclone of the multi-cyclone preheater, in the direction of the flow of the combustion flue gases to the means for discharging the combustion flue gases.

Preferably, the combustion flue gases are collected in step a) at a temperature of between 180 and 800° C., preferably between 200° C. and 500° C., very preferably between 250° C. and 500° C.

In one particular embodiment according to the invention, said step b) comprises the following substeps:
i) the combustion flue gases collected in step a) are cooled;
ii) the cooled combustion flue gases are sent to a first separation vessel to obtain a first gas effluent and a first liquid effluent;
iii) the first gas effluent is sent to a first compressor;
iv) the compressed first gas effluent is cooled;
v) the cooled, compressed first gas effluent is sent to a second separation vessel to obtain a second gas effluent and a second liquid effluent;
vi) the second gas effluent is sent to a second compressor;
vii) the compressed second gas effluent obtained in step vi) is brought into contact with at least one portion of said second liquid effluent obtained in step v) to form said treated combustion flue gases.

Preferably, said combustion flue gases are cooled in step i) to a temperature of between 60 and 80° C.

Advantageously, said first gas effluent is cooled in step iv) to a temperature of between 30 and 60° C.

Advantageously, the reaction stream is preheated to a temperature of between 500 and 850° C.

Preferably, a step in which the combustion flue gases are filtered is carried out between step a) and b) or c) of said process.

Advantageously, said stream of light hydrocarbons is a natural gas or a liquefied petroleum gas.

Preferably, steam and/or oxygen is provided between step a) and d) of said process.

Advantageously, the provision of oxygen is carried out by means of an oxygen source chosen from atmospheric air from the air or an oxygen stream from a cryogenic air separation process, from a pressure swing adsorption process, or from a vacuum swing adsorption process.

Advantageously, said combustion flue gases comprise a CO₂ content of between 10 and 30 vol %.

Preferably, the reaction stream comprises:
an O₂/HC volume ratio of between 0.05 and 0.3;
a CO₂/HC volume ratio of between 0.15 and 0.5;
an H₂O/HC volume ratio of between 0.2 and 0.75;
an N₂/HC volume ratio of between 0.1 and 2.0.

Advantageously, the syngas has an H₂/CO volume ratio of between 1 and 3.

Preferably, the tri-reforming reactor comprises at least one supported catalyst containing an active phase comprising at least one metal element in oxide form or in metal form, chosen from groups VIIIB, IB and IIB, alone or as a mixture.

### DESCRIPTION OF THE FIGURES

FIG. 1 is a simplified diagrammatic representation of a cement clinker production unit.

FIG. 2 is a simplified diagrammatic representation of the process according to the invention.

FIG. 3 is a diagrammatic representation of one particular embodiment of the process according to the invention, wherein the combustion flue gases collected in the cement clinker production unit (step a) are treated (step b) before being brought into contact with a stream of light hydrocarbons (step c) to form the reaction stream of the catalytic tri-reforming reaction (step d).

### DETAILED DESCRIPTION OF THE INVENTION

Definitions

Hereinafter, groups of chemical elements are given according to the CAS classification (CRC Handbook of Chemistry and Physics, published by CRC Press, Editor in Chief D. R. Lide, 81^{st} edition, 2000-2001). For example, Group VIII according to the CAS classification corresponds to the metals of Columns 8, 9 and 10 according to the new IUPAC classification. Textural and structural properties of the support and of the catalyst described below are determined by the characterization methods known to those skilled in the art. The total pore volume and the pore distribution are determined in the present invention by nitrogen porosimetry as described in the book “Adsorption by powders and porous solids. Principles, methodology and applications”, written by F. Rouquérol, J. Rouquérol and K. Sing, Academic Press, 1999.

The specific surface area is understood to mean the BET specific surface area (S_{BET} in m²/g) determined by nitrogen adsorption in accordance with standard ASTM D 3663-78 developed from the Brunauer-Emmett-Teller method described in the journal “The Journal of the American Chemical Society”, 1938, 60 (309).

In the context of the present invention, the term “light hydrocarbons” denotes hydrocarbon-based compounds comprising between 1 and 4 carbon atoms (C₁-C₄).

Description of the Process

Clinker production is an industrial process which gives off high amounts of carbon dioxide (CO₂) (approximately 5% of CO₂ emissions of anthropic origin). This large amount of CO₂ emissions for cement works comes not only from the intensive energy consumption in the clinker production process, but especially from the limestone calcining reaction, which releases a very large amount of CO₂ (0.5 tonne of CO₂ produced by this mechanism for each tonne of clinker produced).

For this reason, the applicant has developed a process for producing a syngas containing CO and H₂ from a stream of light hydrocarbons and of combustion flue gases directly from a calcining kiln of a cement clinker production unit, said combustion flue gases having the advantage of containing a high CO₂ concentration because of the decarbonation of the raw material during the clinkering step. This allows a production of syngas with a better energy yield, a lower discharge of greenhouse gases, and a high carbon yield.

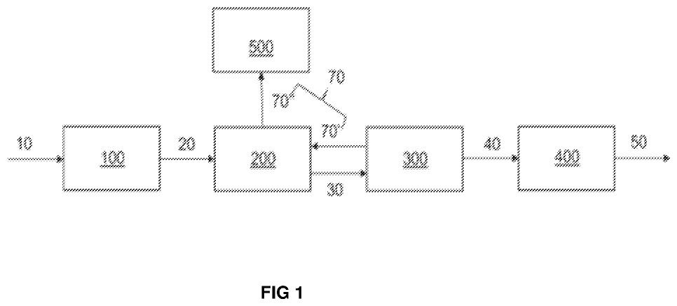

With reference to FIG. 1, diagrammatically illustrating a cement clinker production unit, the limestone 10 is sent to a clinker burning shop comprising a grinder/dryer 100 to obtain the raw mix 20. The raw mix 20 is then sent to a multi-cyclone preheater 200 to obtain a preheated raw mix 30. The preheated raw mix 30 is then transferred into a calcining kiln 300 to obtain the cement clinker 40. The cement clinker 40 is then sent to a cooler 400 to obtain a cooled clinker 50.

Generally, the multi-cyclone preheater 200 used to preheat the raw mix 20 comprises several levels (i.e. several cyclones). Typically, the multi-cyclone preheater 200 comprises between 4 and 6 cyclones. In this step, the raw mix 20 is preheated by thermal exchange in the multi-cyclone preheater 200 with the combustion flue gases 70′ from the calcining kiln 300. The combustion flue gases 70″ from the multi-cyclone preheater 200 are then sent to the outside of the clinker production unit by means of a device for discharging the combustion flue gases 500, such as chimneys. According to the process for producing syngas according to the invention, the combustion flue gases 70 (70′ and/or 70″) obtained after the calcining of the raw mix to cement clinker in the calcining kiln 300 are collected upstream of the means for discharging the combustion flue gases 500 and then brought into contact with a stream of light hydrocarbons in order to form a reaction stream, the latter being sent to a tri-reforming reactor making it possible to obtain the syngas.

More particularly, with reference to FIGS. 1 and 2, the process for producing a syngas containing CO and H₂ according to the invention is carried out from a stream of light hydrocarbons 110 and from combustion flue gases 70 from a cement clinker production unit comprising a multi-cyclone preheater 200, a calcining kiln 300, and a means for discharging the combustion flue gases 500 to the outside of said unit, said process comprising the following steps:
a) the combustion flue gases 70 (70′ and/or 70″) from the calcining kiln 300 of the clinker production unit are collected upstream of the means for discharging the combustion flue gases 500 (cf. FIG. 1), preferably without carrying out an intermediate separation step;
b) optionally, said combustion flue gases 70 collected in step a) are treated to obtain treated combustion flue gases 101;
c) a reaction stream 113 comprising a stream of light hydrocarbons 110 containing methane and the combustion flue gases 70 collected in step a) or the treated combustion flue gases 101 obtained in step b) is prepared; and
d) the reaction stream 113 is sent to a tri-reforming reactor 1009 to obtain a syngas 114, said tri-reforming reactor 1009 operating at a temperature of between 650 and 900° C., a pressure between 0.1 and 5 MPa, and an HSV of between 0.1 and 200 Nm³/h.kg_{catalyst}.

Steps a) to d) are described in greater detail below.

Step a)

In step a), the combustion flue gases 70 from the clinker production unit are collected upstream of the means for discharging the combustion flue gases 500 to the outside of the clinker production unit, preferably without carrying out an intermediate separation step.

Preferably, the combustion flue gases 70 are collected at the level of the multi-cyclone preheater 200 of said cement clinker production unit. Even more preferentially, the combustion flue gases 70 are collected at the level of the penultimate or of the final cyclone (not represented in the figures) of the multi-cyclone preheater 200.

All or some of the combustion flue gases from the clinker production unit can be processed.

When the collecting of the combustion flue gases is not carried out at the level of the final cyclone of the preheater, approximately 10 to 50 vol % of the combustion flue gases are collected so as not to disrupt the operation of the clinker production unit.

The flow rate of the combustion flue gases 70 collected in step a) is between 10 000 and 500 000 Nm³/h, preferably between 30 000 and 300 000 Nm³/h.

The combustion flue gases 70 collected in step a) comprise CO₂, H₂O, O₂, and N₂.

More particularly, the combustion flue gases 70 comprise between 10 vol % and 30 vol % of CO2, preferably between 15 vol % and 30 vol %, very preferably between 15 vol % and 25 vol %.

More particularly, the combustion flue gases comprise between 5 vol % and 20 vol % of H2O, preferably between 10 vol % and 20 vol %, very preferably between 10 vol % and 15 vol %.

More particularly, the combustion flue gases comprise between 1 vol % and 15 vol % of O₂, preferably between 2 vol % and 10 vol %, very preferably between 2 vol % and 5 vol %.

More particularly, the combustion flue gases comprise between 50 vol % and 80 vol % of N₂, preferably between 50 vol % and 70 vol %, very preferably between 55 vol % and 65 vol %.

Preferably, the temperature of the combustion flue gases 70 collected in step a) is between 180° C. and 800° C., preferably between 200° C. and 500° C., very preferably between 250° C. and 500° C.

Advantageously, a step of filtering the combustion flue gases 70 collected in step a) is carried out in order to decrease the dust content of the combustion flue gases. For example, the filtering step can be carried out by means of bag filters or ceramic filters. Preferably, the dust content in the combustion flue gases 70 after the filtering step is less than 1000 mg/m³, very preferably less than 100 mg/m³.

Step b) (Optional)

In one particular embodiment of the process according to the invention, a step b) of treating the combustion flue gases 70 collected in step a) is carried out.

This step enables an adjustment by condensation of the amount of water required for the catalytic tri-reforming reaction and also a decrease in the electric power consumed by decreasing the suctioned volume flow rate.

In step b) of the process according to the invention, the combustion flue gases 70 obtained in step a) are treated to obtain treated combustion flue gases 101.

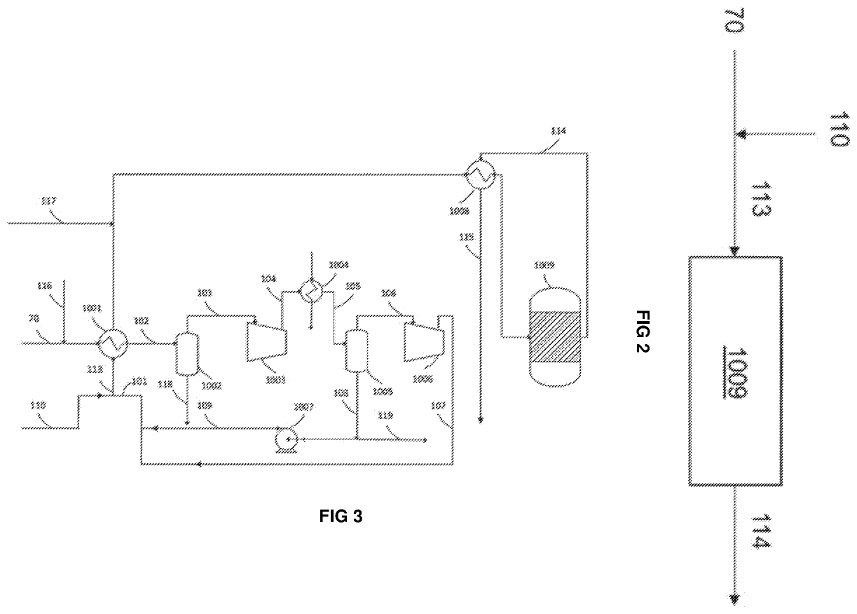

With reference to FIG. 3, when step b) of treating the combustion flue gases 70 collected in step a) is carried out, step b) comprises the following substeps:
i) the combustion flue gases 70 collected in step a) are cooled;
ii) the cooled combustion flue gases 102 are sent to a first separation vessel 1002 to obtain a first gas effluent 103 and a first liquid effluent 118;
iii) the first gas effluent 103 is sent to a first compressor 1003 to obtain a compressed first gas effluent 104;
iv) the compressed first gas effluent 104 is cooled to obtain a cooled, compressed first gas effluent 105;
v) the cooled, compressed first gas effluent 105 is sent to a second separation vessel 1005 to obtain a second gas effluent 106 and a second liquid effluent 108;
vi) the second gas effluent 106 is sent to a second compressor 1006 to obtain a compressed second gas effluent 107;
vii) the compressed second gas effluent 107 obtained in step vi) is brought into contact with at least one portion of said second liquid effluent 108 obtained in step v) to form said treated combustion flue gases 101.

The temperature of the combustion flue gases 70 collected in step a) is between 180° C. and 800° C., preferably between 200° C. and 500° C., very preferably between 250° C. and 500° C. The pressure of the combustion flue gases 70 collected in step a) is about between 0.05 and 0.20 MPa (0.5 and 2.0 bar), preferably between 0.08 and 0.15 MPa (0.8 and 1.5 bar).

In step i), the combustion flue gases 70 are cooled to a temperature of between 60 and 80° C. by transferring their heat to the stream 113 in a first exchanger 1001. The cooled combustion flue gases 102 are sent to a guard vessel 1002 to obtain a first gas effluent 103 and a first liquid effluent 118 (step ii);

The pressure of the first gas effluent 103 is increased between 0.1 and 0.2 MPa (1 and 2 bar) by a first compressor 1003 (step iii) from where a first compressed gas effluent 104 exits, said first gas effluent being cooled to a temperature of between 30 and 60° C. by a water exchanger 1004 (step iv).

Said cooled, compressed first gas effluent 105 is sent to a separation vessel 1005 to obtain a second gas effluent 106 and a second liquid effluent 108 composed essentially of condensed water (step v).

The pressure of the second gas effluent 106 from the separator 1005 is increased between 0.1 and 0.5 MPa (1 and 5 bar) by a second compressor 1006 from where a compressed second gas effluent 107 exits (step vi).

Finally, at least one portion of the compressed second gas effluent 107 obtained in step vi) is brought into contact with at least one portion of said second liquid effluent 108 obtained in step v) (via the line 109) to form the treated gas feedstock 101 (step vii). The other portion of the second liquid effluent is discharged from the process via the line 119, preferably at a flow rate of about from 15 vol % to 25 vol % relative to the total flow rate of the second liquid effluent 108.

Preferably, said at least one portion of the second liquid effluent 109 passes through a pump 1007 before being mixed with the compressed second gas effluent 107.

Step c)

According to step c) of the process, a reaction stream 113 comprising a stream of light hydrocarbons 110 containing methane and the combustion flue gases 70 collected in step a) (cf. FIG. 2) or the treated combustion flue gases 101 (cf. FIG. 3) of step b) is prepared. The reaction stream 113 is then sent to the tri-reforming reactor 1009.

Preferably, the hydrocarbon source is a natural gas or liquefied petroleum gas, very preferably the hydrocarbon source is a natural gas comprising at least 50 vol % of methane, preferably at least 60 vol % of methane, and more preferentially at least 70 vol % of methane.

In the particular embodiment wherein the process according to the invention comprises a step of treating the combustion flue gases collected in step a) (i.e, when step b) is carried out), the reaction stream 113 is obtained by bringing the second liquid effluent 108, the second compressed gas effluent 107 and the stream of light hydrocarbons into contact.

Advantageously, the reaction stream 113 is reheated in an exchanger 1001 by the combustion flue gases 70 collected in step a) of the process. The reaction stream from this exchanger 1001 can then be brought to a temperature close to that of the catalytic tri-reforming reaction, to a temperature of between 500 and 850° C., preferably to a temperature of between 750° C. and 850° C., via the heat exchanger 1008. The reaction stream 113 is then sent to the tri-reforming reactor 1009.

Preferably, the O₂/HC volume ratio of the reaction stream 113 is between 0.05 and 0.3, very preferably O₂/HC by volume is between 0.07 and 0.2.

Preferably, the CO₂/HC volume ratio of the reaction stream 113 is between 0.15 and 0.5, very preferably CO₂/HC by volume is between 0.15 and 0.4.

Preferably, the H₂O/HC volume ratio of the reaction stream 113 is between 0.2 and 0.75, very preferably H₂O/HC by volume is between 0.25 and 0.7.

Preferably, the N₂/HC volume ratio of the reaction stream 113 is between 0.1 and 2, very preferably N₂/HC by volume is between 0.5 and 1.2.

Depending on the composition of the combustion flue gases 70 collected in step a) or of the treated combustion flue gases 101 obtained in step b), it is possible to provide steam and/or oxygen in any proportion in order to obtain a reaction stream 113 with desired volume ratios between the CO₂, H₂O and O₂ reagents, and the hydrocarbon (HC) source. These provisions can be carried out together or separately, and before or after the mixing of the cement works gas effluent with the hydrocarbon source. In particular, these provisions can be carried out either by means of a stream 116 added directly to the combustion flue gases 70 collected in step a), or added by means of a stream 117 added to the reaction stream 113 before or after passing through the exchanger 1001.

When a provision of oxygen is carried out, the oxygen source may preferably be atmospheric air or a stream of oxygen either from a cryogenic air separation unit (ASU) process, or from a pressure swing adsorption (PSA) process, or from a vacuum swing adsorption (VSA) process. When a provision of steam is carried out, any source of steam or process for generating steam may be used.

Step d)

In step d), the feedstock containing the light hydrocarbons, CO₂, H₂O, O₂ and N₂ is conveyed to a catalytic reactor 1009 so as to convert said feedstock and to obtain an effluent containing carbon monoxide and hydrogen.

The catalytic tri-reforming reactor 1009 may be any type of reactor suitable for converting the gas feedstock. Preferably, the catalytic reactor will be a fixed bed or fluidized bed reactor. The reaction zone is filled with a heterogeneous catalyst which has an active phase in oxide or metal form composed of at least one element chosen from groups VIII, IB and IIB, alone or as a mixture. The catalyst comprises an active-phase content, expressed as % by weight of elements relative to the total weight of the catalyst, of between 0.1% and 60%, preferably between 1% and 30%. Advantageously, the catalyst used comprises a weight content of between 20 ppm and 50%, expressed as % by weight of element relative to the total weight of the catalyst, preferably between 50 ppm and 30% by weight, and very preferably between 0.01% and 5% by weight, of at least one doping element chosen from groups VIIB, VB, IVB, IIIB, IA (alkali metal element), IIA (alkaline-earth metal element), IIIA and VIA, alone or as a mixture. The catalyst comprises a support containing a matrix of at least one refractory oxide based on elements such as Mg, Ca, Ce, Zr, Ti, Al or Si, alone or as a mixture. The support on which said active phase is deposited and also the optional doping agents can have a morphology in the form of balls, of extruded objects (for example in the form of trilobes or quadrilobes), of pellets, or of optionally perforated cylinders, or can have a morphology in the form of a powder of variable particle size.

When the active phase of the catalyst is in metal form, a step of temperature activation under reducing gas may be carried out before the injection of the reaction stream 113 into the reactor 1009.

In the reaction zone, the reaction stream is brought to a temperature of 650° C. to 900° C. and a pressure of 0.1 to 5.0 MPa (1 bar to 50 bar). The hourly space velocity of the reaction stream is between 0.1 and 200 Nm³/h.kg_{catalyst}, preferably between 1 and 100 Nm³/h.kg_{catalyst}, very preferably between 1 and 50 Nm³/h.kg_{catalyst}. The effluent 114 from the reactor 1009 comprises carbon monoxide and hydrogen in an H₂/CO volume ratio of between 1 and 3, preferably between 1.5 and 2.7, very preferably between 1.7 and 2.7. Preferably, this effluent comprises no more than 50% by volume of N₂, very preferably no more than 30% by volume.

Advantageously, the effluent 114 passes through a heat exchanger (heat exchanger 1008 in the embodiment as illustrated in FIG. 3) in order to obtain a cooled effluent 115 between 120 and 250° C. which can be exploited directly by any of the routes known to those skilled in the art. Specifically, the effluent obtained according to the invention has the characteristics of a syngas and can be exploited directly by any of the routes known to those skilled in the art. Preferably, the effluent comprising carbon monoxide is exploited in Fischer Tropsch synthesis for the production of synthesis fuels. Before exploitation of the effluent, it may be advantageous to carry out a purification step, in particular De-Nox and/or De-Sox step, by any process known to those skilled in the art.

The invention is illustrated by the examples that follow, which are not in any way limiting in nature.

### EXAMPLES

### Example 1

### Conversion of a Cement Works Effluent into a Gas Composition Comprising Carbon Monoxide and Dihydrogen (in Accordance with the Invention)

The combustion flue gases from the clinker production are collected at the level of the multi-cyclone preheater of the clinker production unit, upstream of the chimney for discharging the combustion flue gases. The combustion flue gases collected comprise 25% by volume of CO₂, 12.5% by volume of H₂O, 3% by volume of O₂ and 59% by volume of N₂. The temperature of the combustion flue gases collected is 450° C. Provisions of steam and of oxygen (by adding atmospheric air), and also a flow of natural gas, are added to these combustion flue gases in order to obtain the following volume ratios:

N₂/HC=1.05;

H₂O/HC=0.33;

CO₂/HC=0.25;

O₂/HC=0.15.

The reaction stream is brought to 850° C. under a pressure of 0.25 MPa (2.5 bar), in the presence of a nickel-based catalyst (HiFUEL R110, Johnson Matthey Plc, Alfa Aesar). The hourly space velocity of the reaction stream is 8 Nm³/h.kg_{catalyst}.

The effluent obtained comprises 25% by volume of CO, 47% by volume of dihydrogen, 3.5% by volume of hydrocarbons, traces of CO₂ and H₂O, and also 24% by volume of N₂.

The H₂/CO molar ratio is about 1.88, which is acceptable for being used as supply for a unit for the production of fuel by the Fischer-Tropsch process.

The CO₂ and hydrocarbon conversions are respectively 97% and 85%. The carbon yield of the reaction relative to the hydrocarbons introduced is 109%.

### Example 2

### Conversion of a Cement Works Effluent into a Gas Composition Comprising Carbon Monoxide and Dihydrogen (in Accordance with the Invention)

The combustion flue gases from the clinker production are collected at the level of the multi-cyclone preheater of the clinker production unit, upstream of the chimney for discharging the combustion flue gases. The combustion flue gases collected comprise 25% by volume of CO₂, 12.5% by volume of H₂O, 3% by volume of O₂ and 59% by volume of N₂. The temperature of the combustion flue gases collected is 450° C. Provisions of steam and of oxygen (by adding atmospheric air), and also a flow of natural gas, are added to these combustion flue gases in order to obtain the following volume ratios:

N₂/HC=0.98;

H₂O/HC=0.66;

CO₂/HC=0.32;

O₂/HC=0.10.

The reaction stream is brought to 850° C. under a pressure of 0.25 MPa (2.5 bar), in the presence of a nickel-based catalyst (HiFUEL® R110, Johnson Matthey Plc, Alfa Aesar). The hourly space velocity of the reaction stream is 8 Nm³/h.kg_{catalyst}.

The effluent obtained comprises 24% by volume of CO, 49% by volume of dihydrogen, 1% by volume of hydrocarbons, 3.4% by volume of CO₂, 1.4% by volume of H₂O, and also 20% by volume of N₂.

The H₂/CO molar ratio is about 2.04, which is acceptable for being used as supply for a unit for the production of fuel by the Fischer-Tropsch process.

The CO₂ and hydrocarbon conversions are respectively 78% and 95%. The carbon yield of the reaction relative to the hydrocarbons introduced is 120%.

Compared with processes for producing syngas having an H₂/CO molar ratio close to 2, such as partial oxidation, steam methane reforming or autothermal reforming, the process according to the invention makes it possible to achieve a carbon yield of greater than 100% relative to the hydrocarbons introduced (a portion of the CO coming from CO₂). Thus, by virtue of a better carbon yield, the process according to the invention enables a less expensive production of a syngas. Specifically, fewer hydrocarbons are consumed per volume of syngas produced at a given H₂/CO molar ratio.

1. A process for producing a syngas containing CO and H₂ from a stream of light hydrocarbons and from combustion flue gases from a cement clinker production unit comprising at least one calcining kiln (300), and a means for discharging the combustion flue gases (500) from the calcining kiln to the outside of said unit, said process comprising the following steps:
a) at least some of the combustion flue gases (70) obtained in said clinker production unit are collected upstream of said means for discharging the combustion flue gases (500);
b) optionally, said combustion flue gases (70) collected in step a) are treated to obtain treated combustion flue gases (101);
c) a reaction stream (113) comprising a stream of light hydrocarbons (110) containing methane and the combustion flue gases (70) obtained in step a) or optionally the treated combustion flue gases (101) obtained in step b) is prepared; and
d) said reaction stream (113) is sent to a tri-reforming reactor (1009) to obtain a syngas (114), said tri-reforming reactor (1009) operating at a temperature of between 650 and 900° C., a pressure of between 0.1 and 5 MPa, and an HSV of between 0.1 and 200 Nm³/h.kg_{catalyst}.

2. The process as claimed in claim 1, wherein the cement clinker production unit comprises a preheater (200) using the combustion flue gases as heat source, placed upstream of the calcining kiln, characterized in that the combustion flue gases (70) are collected at the level of the preheater (200) of said cement clinker production unit.

3. The process as claimed in claim 2, wherein the preheater is a multi-cyclone preheater, characterized in that said combustion flue gases (70) are collected at the level of the penultimate or final cyclone of the multi-cyclone preheater (200), in the direction of the flow of the combustion flue gases to the means for discharging the combustion flue gases (500).

4. The process as claimed in claim 1, characterized in that the combustion flue gases (70) are collected in step a) at a temperature of between 180 and 800° C.

5. The process as claimed in claim 1, wherein step b) of treating the combustion flue gases obtained in step a) is carried out, said step b) comprising the following substeps:
i) the combustion flue gases (70) collected in step a) are cooled;
ii) the cooled combustion flue gases (102) are sent to a first separation vessel (1002) to obtain a first gas effluent (103) and a first liquid effluent (118);
iii) the first gas effluent (103) is sent to a first compressor (1003) to obtain a compressed first gas effluent (104);
iv) the compressed first gas effluent (104) is cooled to obtain a cooled, compressed first gas effluent (105);
v) the cooled, compressed first gas effluent (105) is sent to a second separation vessel (1005) to obtain a second gas effluent (106) and a second liquid effluent (108);
vi) the second gas effluent (106) is sent to a second compressor (1006) to obtain a compressed second gas effluent (107);
vii) the compressed second gas effluent (107) obtained in step vi) is brought into contact with at least one portion of said second liquid effluent (108) obtained in step v) to form said treated combustion flue gases (101).

6. The process as claimed in claim 5, characterized in that said combustion flue gases (70) are cooled, in step i), to a temperature of between 60 and 80° C.

7. The process as claimed in claim 5, characterized in that said first gas effluent (104) is cooled, in step iv), to a temperature of between 30 and 60° C.

8. The process as claimed in claim 1, characterized in that the reaction stream (113) is preheated to a temperature of between 500 and 850° C.

9. The process as claimed in claim 1, characterized in that a step wherein the combustion flue gases (70) are filtered is carried out between step a) and b) or c) of said process.

10. The process as claimed in claim 1, characterized in that said stream of light hydrocarbons (110) is a natural gas or a liquefied petroleum gas.

11. The process as claimed in claim 1, characterized in that a provision of steam and/or of oxygen is carried out between step a) and d) of said process.

12. The process as claimed in claim 11, characterized in that the provision of oxygen is carried out by means of an oxygen source chosen from atmospheric air from the air or an oxygen stream from a cryogenic air separation process, from a pressure swing adsorption process, or from a vacuum swing adsorption process.

13. The process as claimed in claim 1, characterized in that the reaction stream (113) comprises:
an O₂/HC volume ratio of between 0.05 and 0.3;
a CO₂/HC volume ratio of between 0.15 and 0.5;
an H₂O/HC volume ratio of between 0.2 and 0.75;
an N₂/HC volume ratio of between 0.1 and 2.0.

14. The process as claimed in claim 1, characterized in that the syngas (114) has an H₂/CO volume ratio of between 1 and 3.

15. The process as claimed in claim 1, characterized in that the tri-reforming reactor (1009) comprises at least one supported catalyst containing an active phase comprising at least one metal element in oxide form or in metal form, chosen from groups VIIIB, IB and IIB, alone or as a mixture.
